(19) United States
(12) Patent Application Publication
(10) Pub. No.: US 2017/0277142 A1
(43) Pub. Date: Sep. 28, 2017

(54) PROCESS CONTROL SYSTEM PERFORMANCE ANALYSIS USING SCENARIO DATA

(71) Applicant: Honeywell International Inc., Morris Plains, NJ (US)

(72) Inventors: Meenakshi Sundaram Krishnaswamy, Edmonton (CA); Carl David McFadden, Palatine, IL (US)

(21) Appl. No.: 15/080,460

(22) Filed: Mar. 24, 2016

(51) Int. Cl. G05B 13/02; G06N 5/02

(52) U.S. Cl. CPC G05B 13/028; G06N 5/02

(57) ABSTRACT

This disclosure provides systems and methods for process control system performance analysis using scenario data. A method includes receiving, by an analysis system, an operating status of a process control system. The method includes identifying, by the analysis system, one or more scenarios in a scenario knowledge base that have at least one output variable that corresponds to the operating status. The method includes producing an output report, by the analysis system, that includes the operating status, the identified one or more scenarios, and one or more input variables or input variable values that correspond to the identified one or more scenarios.

### TECHNICAL FIELD

This disclosure relates generally to analyzing the performance of process control or monitoring systems (collectively, “process control systems”). More specifically, this disclosure relates to an systems and methods for using “what-if” scenario data for analyzing process control or system performance.

### BACKGROUND

Process plants are often managed using industrial process control and automation systems. Conventional control and automation systems routinely include a variety of networked devices, such as servers, workstations, switches, routers, firewalls, safety systems, proprietary real-time controllers, and industrial field devices. Process and equipment performance bottleneck/issues are common in process industries. Improved tools for analyzing the performance of such process control systems are desirable.

### SUMMARY

This disclosure provides systems and methods for process control system performance analysis using scenario data. A method includes receiving, by an analysis system, an operating status of a process control system. The method includes identifying, by the analysis system, one or more scenarios in a scenario knowledge base that have at least one output variable that corresponds to the operating status. The method includes producing an output report, by the analysis system, that includes the operating status, the identified one or more scenarios, and one or more input variables or input variable values that correspond to the identified one or more scenarios.

A method for building the scenario knowledge base includes receiving the one or more input variables and corresponding input variable values. The method includes operating at least a portion of the process control system according to the one or more input variable values. The method includes identifying at least one output variable based on the operation of the at least a portion of the process control system. The method includes building a scenario that includes the one or more input variables, the corresponding input variable values, and the at least one output variable. The method includes storing the scenario in the scenario knowledge base.

In various embodiments, operating at least a portion of the process control system is performed by simulating the operation of the at least a portion of the process control system. In various embodiments, the input variables are variables or parameters that alter the performance of equipment of the process control system. In various embodiments, the output variables are measured characteristics of the process control system performance that are associated with a change in the input variables. In various embodiments, the input variables of the identified one or more scenarios are identified as likely causes of the operating status. In various embodiments, the output report is transmitted or displayed to a user.

Other technical features may be readily apparent to one skilled in the art from the following figures, descriptions, and claims. Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases may be provided throughout this patent document, and those of ordinary skill in the art should understand that in many, if not most instances, such definitions apply to prior, as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates a more detailed view of one example of an analysis system in accordance with disclosed embodiments; and

FIG. 3 illustrates a flowchart of a process in accordance with disclosed embodiments.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

It can be important that process control systems manage or monitor each system or device so that the process as a whole operates as efficiently as possible. It can be even more important to eliminate possible downtime where some or all of the system is not working correctly. Disclosed embodiments include systems and methods that can help identify potential issues in real time and perform scenario analysis in a “drill-down.” This can aid users in making faster and more accurate decisions in response to system issues, and can save downtime or control performance loss.

Disclosed embodiments can dynamically create a “scenario” for a selected fault so that the resulting system response can be identified and analyzed. Thereafter, similar response “symptoms” can be recognized and associated with the specific fault. A fault detected could be from a mechanical, process, operation, or equipment problem.

Disclosed embodiments include systems and methods for a process control system to generate one or more scenarios to troubleshoot problems post-fault as well as to detect patterns for the process control system to become proactive in detecting event or symptoms corresponding to any potential failure. Various embodiments can include discovering the initial knowledge by identifying the cluster or variables that relate to a fault from the engineering configuration of the process control system. Various embodiments can include detecting events based on a statistically significant change on process variable from a baseline across area or unit or plant and correlating the events to faults with a pattern. Various embodiments can include generating the scenarios and storing them to a scenario knowledge base for what-if analyses to troubleshoot and provide recommendations. Various embodiments can include attaching each scenario with a ranking of possible faults to provide directed trouble shooting.

A “baseline,” as used herein, of an equipment, unit or plant is the time period of reference datasets to compare for all variables being monitored. Disclosed embodiments can set a default baseline as the system startup time of a particular window size which then can be modified. Disclosed embodiments can modify the baseline on a device, asset, or asset hierarchy for changing the reference time. An “asset,” as used herein, refers to a system, component, device, or other element that can be monitored as described herein, and the asset hierarchy refers to a plurality of assets that interact with each other.

For example, disclosed embodiments can create a what-if scenario by altering input variables, such as process or machine parameters, for specific system components and observing the corresponding system response. As one example, the operating speed of a motor could be changed using a new input variable, to represent an operational “fault.” The resulting system response could include higher energy consumption, higher heat generation, effects on other system components, flaws in resulting product, and others. The identified system response can be stored as “output variables” in a knowledge base along with the input variables. Thereafter, when the process control system identifies specific operational problems, the system can compare the operational problems to the output variables to diagnose the “symptoms” of the problem. Using the knowledge base, the system can identify the output variables that are similar to the operational problem and then identify the associated input variable(s), such as the change in the operating speed of the motor. The system can then designate the motor speed as a possible source of the operational problem.

Disclosed embodiments can dynamically generate what-if scenarios and perform corresponding analyses. These analyses can consider respective fault time period data and “snapshots” of system status, and can be used to identify root causes of system problems and to improve overall performance of plant.

Disclosed embodiments include a processor-implemented tool to perform scenario analysis that can optionally “attach” or associate a given scenario with a system fault. The tool can aggregate independent and dependent variables for scenario studies, leveraging asset relationships and asset attributes in relation to a specific fault under investigation. Asset relationships can be defined, for example, via an asset hierarchy that defines how each system, component, or other asset is dependent on or influences other assets. Asset attributes can be used to define the input and output variables related to each asset.

Various embodiments can identify all input and output variables across a unit, plant, or other system being analyzed. In some cases, one or more of the variables can be designated as controlled variables.

Various embodiments include a user interface to allow a user to enter or review data relevant to the analysis. For example, the system can interact with the user to determine input/output variables values at the time of fault, and show trends before and after a fault, for example ±2 hours. The system can interact with the user to aggregate and show related events to understand how events developed over period so that the user can more clearly understand root cause, for example, over a full day or the most recent 20 events. In various embodiments, as the system receives updated data, the system can update any scenarios and analysis.

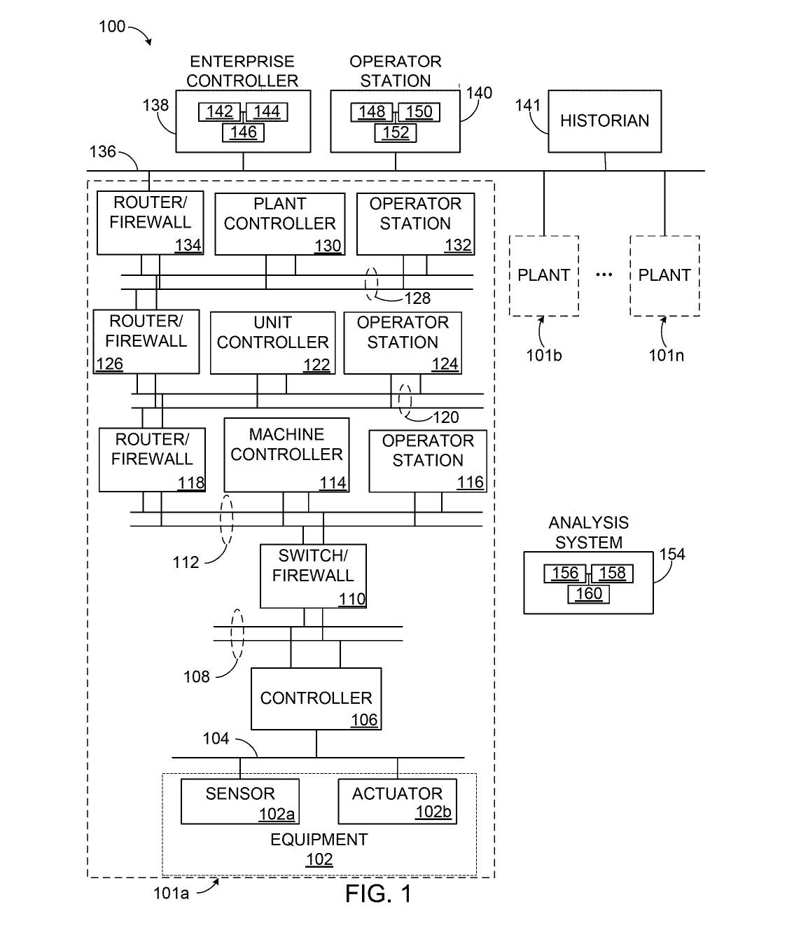

FIG. 1 illustrates an example industrial process control, monitoring, and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b (also, cumulatively, “equipment 102”). The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system. Equipment 102 not intended to be limiting, but include any number of devices or components that can be controlled by system 100, and can include any equipment that can be monitored or controlled by system 100, such as motors, pumps, heat exchangers, turbines, compressors, control valves, other instruments, etc.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, actuators 102b, or other equipment 102).

Access to the unit-level controllers 122 may be provided by one or more operator stations 124. Each of the operator stations 124 includes any suitable structure for supporting user access and control of one or more components in the system 100.

Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, 138 could include one or more processing devices 142 and one or more memories 144 for storing instructions and data used, generated, or collected by the processing device(s) 142. Each of the controllers 106, 114, 122, 130, 138 could also include at least one network interface 146, such as one or more Ethernet interfaces or wireless transceivers. Also, each of the operator stations 116, 124, 132, 140 could include one or more processing devices 148 and one or more memories 150 for storing instructions and data used, generated, or collected by the processing device(s) 148. Each of the operator stations 116, 124, 132, 140 could also include at least one network interface 152, such as one or more Ethernet interfaces or wireless transceivers.

As noted above, analysis and identification of faults is of increasing concern with respect to industrial process control and automation systems. Faults and inefficiencies in any of the components in the system 100 can be analyzed and addressed using techniques as disclosed herein.

Disclosed embodiments can perform process control system performance analysis using scenario data and related methods as disclosed herein. This is accomplished (among other ways) using an analysis system 154. Among other things, the analysis system 154 supports a technique for analysis of faults, inefficiencies, and other problems in an industrial control systems (ICS) and other systems. The analysis system 154 includes any suitable structure that is or can be configured to perform processes as disclosed herein. Here, the analysis system 154 includes one or more processing devices 156; one or more memories 158 for storing instructions and data used, generated, or collected by the processing device(s) 156; and at least one network interface 160. Each processing device 156 could represent a microprocessor, microcontroller, digital signal process, field programmable gate array, application specific integrated circuit, or discrete logic. Each memory 158 could represent a volatile or non-volatile storage and retrieval device, such as a random access memory, Flash memory, hard drive, or other computer-readable storage medium. Each network interface 160 could represent an Ethernet interface, wireless transceiver, or other device facilitating external communication. The functionality of the analysis system 154 could be implemented using any suitable hardware or a combination of hardware and software/firmware instructions. The analysis system 154 can further include other data processing system hardware, such as input and output devices to display data to users and receive data from users as described herein.

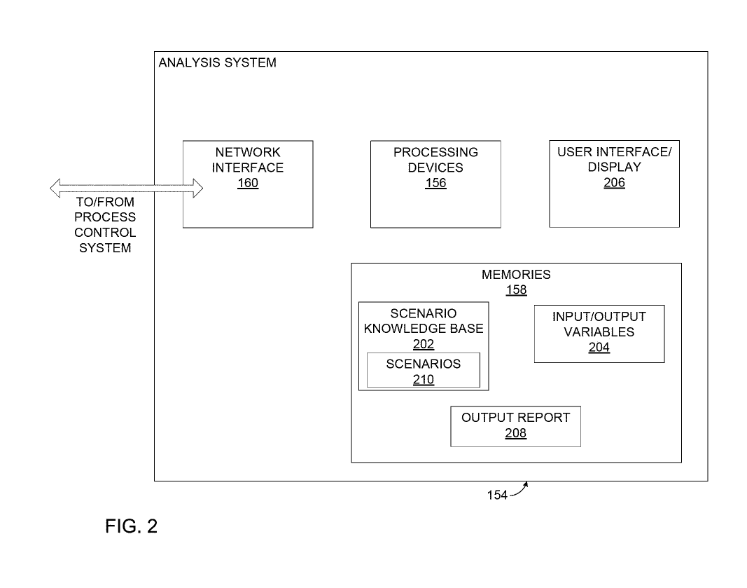

FIG. 2 illustrates a more detailed view of one example of an analysis system 154 in accordance with disclosed embodiments, that can be configured to perform processes as described herein.

FIG. 2 illustrates the analysis system 154, processing devices 156, memories 158, and network interface 160 as described above, as well as a user interface/display 206. One or more of the memories 158 can store such elements as a scenario knowledge base 202, input/output variables 204 (and corresponding values), and an output report 208. The scenario knowledge base 202 stores one or more scenarios 210 as described herein. The user interface/display 206 can be used to interact with a user to develop scenarios 210, receive or display input/output variables 204, display the output report 208, and to perform other functions are described herein. The network interface 160 communicates with the industrial process control and automation system 100 to perform functions as described herein, including but not limited to updating input variables to the equipment 102 of the process control system 100, reading output variables of the process control system 100, and otherwise controlling or monitoring the process control system 100 to develop, apply, or analyze scenarios and faults as described herein.

The input variables, as used herein, refer to any variables or parameters that can be used to alter the performance of any of the equipment 102 in accordance with a scenario. The output variables, as used herein, refer to any measured characteristics or system response of any of the equipment 102 that can be associated with or linked to a change in the input variables.

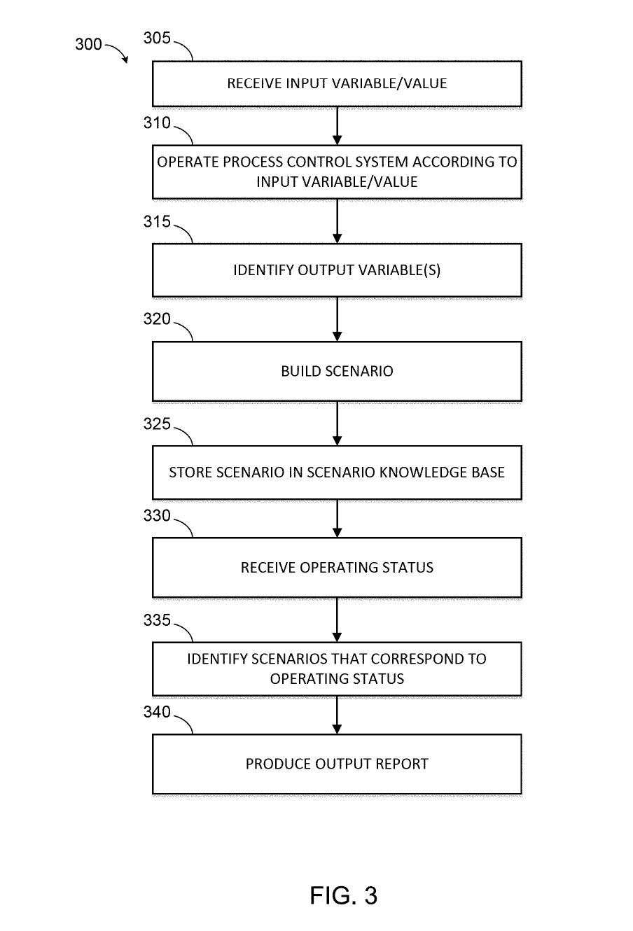

FIG. 3 illustrates a flowchart of a process 300 in accordance with disclosed embodiments, that can be performed, for example, by the analysis system 154 or other data processing system, referred to generically below as the “system” or “analysis system.”

The analysis system receives at least one input variable value for at least one input variable for at least one equipment controlled by a process control system (305). “Receiving,” as used herein, can include loading from storage, receiving from another device or process, receiving via an interaction with a user, or otherwise. For example, the input variable could be “motor speed” and the value for the input variable could be 2500 RPM.

The analysis system operates at least a portion of the process control system, including the equipment, according to the input variable value(s) (310). For example, the motor can be operated at the motor speed of 2500 RPM, and some or all of the rest of the process control system is also operated so that the effects of the particular input variable can be evaluated.

The analysis system identifies at least one output variable corresponding to the input variable(s) (315), based on the operation of the process control system. The output variable can be any condition of any equipment that is influenced by the input variable. Identifying at least one output variable can include identifying clusters or variables that relate to a fault from the engineering configuration of the process control system, particularly those caused by the input variable value(s). Identifying at least one output variable can include detecting events and output variables based on a statistically significant change in the output variable(s) from a previously-stored baseline for an asset, area, unit, or plant and correlating these events or output variables to faults with a pattern.

For example, one output variable could be the motor temperature, which is identified as corresponding to the input variable. Another example could be the output rate of another component driven by the motor, where the output is identified as corresponding to the input variable. As should be clear, an input variable for a given piece of equipment may influence that piece of equipment or other pieces of equipment. The analysis system can identify, for any input variables or input variable values, output variables in the same or any other piece of equipment that are influenced by and therefore “correspond” to the input values.

The analysis system builds a scenario that includes the input variables, input variable values, and the output variables (320). The scenario therefore identifies one or more output variables that correspond to one or more input variables, so that each scenario reflects an effect and its corresponding cause.

The analysis system stores the scenario in a scenario knowledge base (325).

Those of skill in the art will recognize that the input variables and values can be selected to mimic possible system faults, errors, or other specific operating conditions. Steps 305-325 generally describe a process for re-creating or pre-creating “what if” potential problems or operating conditions to identify the “symptoms” that can be associated with each of the operating conditions. While this example describes performing these processes “live” using actual equipment, in other embodiments, the operation of the process control system and equipment is simulated according to the input variables/values and the output variables are produced according to the simulation.

Steps 305-325 can be performed repeatedly using different input variables/values to build a scenario knowledge base that includes multiple scenarios so that problems in the process control system can be identified more readily as described herein. As the scenarios are developed, there may be cases where an output variable corresponds to more than one input variable; that is, where a symptom has more than one potential cause. Each scenario in the scenario knowledge base can therefore include a ranking of the most likely input variables/values for each of those scenarios. In this way, the analysis system can identify or rank the most likely cause of each fault or problem.

Thereafter, the analysis system receives an operating status of the process control system (330). The “operating status,” as used herein, is intended to refer to any identifiable fault, behavior, output, operating condition, or other “symptom” of the process control system for which an operator may wish to determine a cause, and specifically can refer to a pattern of input variable change. The operating status, in various embodiments, can be received directly from the process control system, input by a user, or otherwise. The operating status can be received by detecting statistically significant changes in the output or input variable(s) from the previously-stored baseline for an asset, area, unit, or plant and correlating these events or output variables to faults or input variable patterns.

Monitoring of the process control system to receive the operating status can be performed, for example, as described in U.S. patent application Ser. No. 13/113,593, filed May 23, 2011, hereby incorporated by reference, but is not required to be performed in this manner.

The analysis system identifies one or more scenarios with output variables that correspond to the operating status (335). For example, if the operating status is an overheating motor, the system can search the scenario knowledge base to identify scenarios where the output variable is the operating temperature of the motor, an overheated or failed motor, or similar factors that correspond to the operating status. The output variable and operating status need not be an exact match; for example, they can be considered “corresponding” if they relate to the similar equipment and similar factors (e.g., heat or energy).

The analysis system produces an output report that includes the operating status, the identified scenarios with output variables that correspond to the operating status, and the input variables/values for each of those identified scenarios (340). As described above, the identified scenarios can be ranked according to the input variables/values that are the most likely cause of the operating status. The output report can be stored, transmitted, or displayed. In this way, for a given operating status (symptom), the analysis system can automatically identify scenarios in the scenario knowledge base that produce similar symptoms and produce a report that identifies the related input variables/values (the likely causes of the symptoms).

In this way, once the scenario knowledge base is built, steps 330-340 can be performed for a given operating status so that the analysis system quickly and automatically identifies the likely cause(s) of the operating status, or, conversely, to identify ways to improve system performance

Building the scenario knowledge base case been seen as an offline analysis of the performance or fault diagnostics that analyzing test conditions, past events, or historical trends of few attributes or other input variables to generate recommendations to improve process or equipment reliability and improve performance. In some embodiments, the analysis system can, but is not required to, use a system and method for multi-domain structural analysis across applications in industrial control and automation systems as described in U.S. patent application Ser. No. 14/012,839, filed Aug. 28, 2013, which is hereby incorporated by reference. Such a process can be used for analysis when building the scenario knowledge base, for identifying the scenarios that correspond to the operating status, or both.

Other use-case examples of processes as disclosed herein could include load sharing between turbines, by manually changing the load ratio input variables and building a scenario as described herein. Similarly, input variables can be used to manually tune equipment parameters to understand the impact or need of equipment maintenance, such as tuning a heat exchanger coefficient and checking the improvement output variables to identify improvements or problems. A corresponding output report, based on a scenario, could recommend that the heat exchanger should be cleaned.

The disclosed processes and scenarios can help an operator to understand cause-and-effect relations in or across equipment, and can aid with fault diagnostics and corrective actions.

The scenario knowledge base can also be used to identify input variables of interest for particular output variables. For example, the scenarios can be searched for those that identify energy-usage changes or performance changes of particular equipment as output variables. Those scenarios then identify the input variables that influence those output variables, and allow a user to quickly identify the equipment parameters (or other input variables) that may need to be adjusted.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with. be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims. For example, various steps or operations described herein can be performed sequentially, concurrently, or in a different order, or may be omitted or repeated in various embodiments.

What is claimed is:

1. A method comprising:
receiving, by an analysis system, an operating status of a process control system;
identifying, by the analysis system, one or more scenarios in a scenario knowledge base that have at least one output variable that corresponds to the operating status; and
producing an output report, by the analysis system, that includes the operating status, the identified one or more scenarios, and one or more input variables or input variable values that correspond to the identified one or more scenarios.

2. The method of claim 1, wherein the analysis system builds the scenario knowledge base by:
receiving the one or more input variables and corresponding input variable values;
operating at least a portion of the process control system according to the one or more input variable values;
identifying at least one output variable based on the operation of the at least a portion of the process control system;
building a scenario that includes the one or more input variables, the corresponding input variable values, and the at least one output variable; and
storing the scenario in the scenario knowledge base.

3. The method of claim 2, wherein operating at least a portion of the process control system is performed by simulating the operation of the at least a portion of the process control system.

4. The method of claim 1, wherein the input variables are variables or parameters that alter a performance of equipment of the process control system.

5. The method of claim 1, wherein the output variables are measured characteristics of performance of the process control system that are associated with a change in the input variables.

6. The method of claim 1, wherein the input variables of the identified one or more scenarios are identified as likely causes of the operating status.

7. The method of claim 1, wherein the output report is transmitted or displayed to a user and includes a ranking of the one or more input variables or input variable values that correspond to the identified one or more scenarios according to a most likely cause of the operating status.

8. An analysis system comprising:
a processing device; and
a memory, the analysis system configured to:
receive an operating status of a process control system;
identify one or more scenarios in a scenario knowledge base that have at least one output variable that corresponds to the operating status; and
produce an output report that includes the operating status, the identified one or more scenarios, and one or more input variables or input variable values that correspond to the identified one or more scenarios.

9. The analysis system of claim 8, wherein the analysis system is configured to build the scenario knowledge base by:
receiving the one or more input variables and corresponding input variable values;
operating at least a portion of the process control system according to the one or more input variable values;
identifying at least one output variable based on the operation of the at least a portion of the process control system;
building a scenario that includes the one or more input variables, the corresponding input variable values, and the at least one output variable; and
storing the scenario in the scenario knowledge base.

10. The analysis system of claim 9, wherein operating at least a portion of the process control system is performed by simulating the operation of the at least a portion of the process control system.

11. The analysis system of claim 8, wherein the input variables are variables or parameters that alter a performance of equipment of the process control system.

12. The analysis system of claim 8, wherein the output variables are measured characteristics of performance of the process control system that are associated with a change in the input variables.

13. The analysis system of claim 8, wherein the input variables of the identified one or more scenarios are identified as likely causes of the operating status.

14. The analysis system of claim 8, wherein the output report is transmitted or displayed to a user and includes a ranking of the one or more input variables or input variable values that correspond to the identified one or more scenarios according to a most likely cause of the operating status.

15. A non-transitory machine-readable medium encoded with executable instructions that, when executed, cause one or more processing devices of an analysis system to:
receive an operating status of a process control system;
identify one or more scenarios in a scenario knowledge base that have at least one output variable that corresponds to the operating status; and
produce an output report that includes the operating status, the identified one or more scenarios, and one or more input variables or input variable values that correspond to the identified one or more scenarios.

16. The non-transitory machine-readable medium of claim 15, wherein the analysis system builds the scenario knowledge base by:
receiving the one or more input variables and corresponding input variable values;
operating at least a portion of the process control system according to the one or more input variable values;
identifying at least one output variable based on the operation of the at least a portion of the process control system;
building a scenario that includes the one or more input variables, the corresponding input variable values, and the at least one output variable; and
storing the scenario in the scenario knowledge base.

17. The non-transitory machine-readable medium of claim 16, wherein operating at least a portion of the process control system is performed by simulating the operation of the at least a portion of the process control system.

18. The non-transitory machine-readable medium of claim 15, wherein the input variables are variables or parameters that alter a performance of equipment of the process control system.

19. The non-transitory machine-readable medium of claim 15, wherein the output variables are measured characteristics of performance of the process control system that are associated with a change in the input variables.

20. The non-transitory machine-readable medium of claim 15, wherein the input variables of the identified one or more scenarios are identified as likely causes of the operating status, and wherein the output report is transmitted or displayed to a user.
